(19) United States
(12) Patent Application Publication
(10) Pub. No.: US 2012/0182217 A1
(43) Pub. Date: Jul. 19, 2012

(54) METHOD OF ARRANGEMENT OF A TOUCHPAD AND/OR JOYSTICK IN AN ELECTRONIC DEVICE

(76) Inventor: Vladimir Vitalievich Miroshnichenko, Ljubertsi (RU)

(21) Appl. No.: 13/138,460

(22) PCT Filed: Sep. 7, 2010
(86) PCT No.: PCT/RU2010/000486

§ 371 Date: Mar. 23, 2012

(30) Foreign Application Priority Data
Oct. 5, 2009 (RU) 2009136784

(51) Int. Cl. G06F 3/041; G06F 3/033

(52) U.S. Cl. 345/161; 345/173

(57) ABSTRACT

It is claimed the method of arrangement of a touchpad, a joystick and a visual display in an electronic device and devices for realization of the method. A touchpad or a part of it or a joystick is made so as to move along electronic device body. A touchpad or a part of it has a fully or partially convex shape. A touchpad or part of it and a joystick or part of it are arranged on different sides of a body of an electronic device comprising a touchpad and a joystick. A touchpad or part of it, a joystick or part of it and a fully or partially touch screen display are arranged on different sides of a body of electronic device comprising a touchpad, a visual display and a joystick. A fully or partially touch screen display is arranged on different sides of a body of electronic device.

### CROSS-REFERENCE TO RELATED APPLICATIONS

This application is a U.S. national stage application of a PCT application PCT/RU2010/000486 filed on 7 Sep. 2010, whose disclosure is incorporated herein in its entirety by reference, which PCT application claims priority of a Russian Federation application RU2009136784 filed on 5 Oct. 2009. The PCT application PCT/RU2010/000486 also contains parts of disclosure absent in the application RU2009136784.

### FIELD OF THE INVENTION

The invention relates to electronic devices and, in particular, to the method of arrangement of a touchpad, a joystick and a visual display in an electronic device and also to the devices for realization of the method.

### BACKGROUND OF THE INVENTION

Regarding to the first embodiment of the invention, which relates to the method of arrangement of a touchpad, a joystick and a visual display in an electronic device, it is known a touchpad to be used to control the electronic device functions (for more details see http://en.wikipedia.org/wiki/Touchpad), it is also known a joystick to be used to control the electronic device functions (for more details see http://en.wikipedia.org/wiki/Joystick), it is known a fully or partially touch screen display to be used to control the electronic device functions (for more details see http://en.wikipedia.org/wiki/Touchscreen).

In regard to the method of arrangement of a touchpad in an electronic device the closest technical solution known in the art is the method of arrangement of a touchpad inside the body of an electronic device (e.g. a mobile phone). For more details see http://www.conceptphones.com/nokia/nibiru-concept-phone-andy-kurovets-design-blending-sci-mythology/. The disadvantage of the specified method is that the arrangement of the touchpad on the lateral side of the body of the electronic device prevents the user from performing manipulations on said touchpad by the hand which holds the device.

In regard to the method of arrangement of a joystick in an electronic device the closest technical solution known in the art is the method of arrangement of a joystick on the lateral side of the electronic device body. For more details see http://en.wikipedia.org/wiki/Nokia_N90. The disadvantage of the specified method is that the arrangement of the joystick on the lateral side of the body of the electronic device prevents the user from performing manipulations on said joystick by the hand which holds the device.

In regard to the method of arrangement of a fully or partially touch screen display in an electronic device described herein there are no close technical solution known in the art.

Regarding to the second embodiment of the invention, which relates to an electronic device wherein a touchpad or a part (sector) of a touchpad or a joystick is made so as to move along the electronic device body. No prior arts equivalent to the second embodiment of the invention described herein have been discovered.

Regarding to the third embodiment of the invention, which relates to an electronic device comprising a touchpad, wherein a touchpad or a part (sector) of a touchpad has a fully or partially convex shape. No prior arts equivalent to the third embodiment of the invention described herein have been discovered.

Regarding to the fourth embodiment of the invention, which relates to an electronic device comprising a touchpad and a joystick, the closest technical solution known in the art is the MXP Wireless Presentation Mouse. For more details see http://www.manhattanproducts.com/en-US/products/7775-mxp-wireless-presentation-mouse. The said device comprises a touchpad, presenter buttons, media player buttons and mouse buttons. The disadvantage of the specified device is that the absence of a joystick in the MXP Wireless Presentation Mouse limits functional capabilities of the specified device.

Regarding to the fifth embodiment of the invention, which relates to the device comprising a touchpad, a visual display and a joystick, the closest technical solution known in the art is the device described in the U.S. provisional application No. 61/180,400. The said U.S. provisional application relates to a hand-held device, comprising a case having first and second major surfaces; a visual display is disposed on the first major surface; a touchpad is disposed on at least one of major surfaces; a processor is operably coupled to a visual display and touch screen; instructions executable by the processor configured to: a) present an image on the visual display containing one or more active elements; b) identify an active portion of the touchpad in response to a user interaction with the touchpad; c) correlate the active portion of touchpad to a corresponding active element in the image on the visual display; d) present a transformed active element on the visual display (U.S. 61/180,400, page 19, lines 1-12). The disadvantage of the specified device is that it is not provided a joystick in the said device. Another disadvantage of the specified device is that it is not provided an opportunity to control an active element displayed on the visual display through manipulations with the joystick or with the touchpad and the joystick. Moreover, the user of the electronic device cannot control at least one active element displayed on the visual display of the electronic device body through his/her manipulations with the touchpad or with the joystick. It is also not provided an opportunity to arrange a touchpad on non-major surfaces of the device body or on several sides of the device body that limits functional capabilities of the specified device.

Regarding to the sixth embodiment of the invention, which relates to the device comprising a visual display, it is known an electronic device wherein one display is placed on each of two opposite sides of the body of said electronic device. For more details see http://www.brighthand.com/default.asp?newsID=12919. No prior arts equivalent to the sixth embodiment of the invention described herein have been discovered.

### OBJECTIVES AND DESCRIPTION OF THE INVENTION

The object and the technical result of the declared method and devices for realization of the method is to expand functional capabilities of the devices, realizing the method.

For proper understanding and interpretation of the text and claims described herein the following terms are used: Joystick is an input device consisting of a stick that pivots on a base and reports its angle or direction to the device it is controlling. A popular variation of the joystick used on modern video game consoles is the analog stick (see http://en.wikipedia.org/wiki/Joystick). An analog stick, sometimes called a control stick or thumbstick, is an input device for a controller (often a game controller). An analog stick is a variation of a joystick, consisting of a protrusion from the controller (see http://en.wikipedia.org/wiki/Analog_stick).

Referring to the first embodiment of the invention the above mentioned technical result is achieved as follows:

A touchpad or a part (sector) of a touchpad or a joystick is arranged partially on the rear side of the electronic device body, or

a touchpad or a part (sector) of a touchpad or a joystick is arranged over the rear side of an electronic device fully or partially, herewith a touchpad or a part of a touchpad or a joystick is connected to the body of an electronic device, or

a touchpad or a part (sector) of a touchpad is arranged at once on the lateral side and on the rear side of the electronic device body, herewith a touchpad itself has at least one bending, or

a touchpad or a part (sector) of a touchpad is arranged at once on the front side, lateral side and on the rear side of the electronic device body, or

a fully or partially touch screen display is arranged at least on three sides of a body of an electronic device.

An electronic device may be a mobile phone or a smartphone or a communicator or a multimedia device or a netbook or a notebook or a tablet computer or an electronic book or a digital camera or a camcorder or other electronic device equipped with a touchpad or other electronic device equipped with a joystick or other electronic device equipped with a touchpad and with a joystick or other electronic device equipped with a touchpad and a fully or partially touch screen display or other electronic device equipped with a joystick and a fully or partially touch screen display or other electronic device equipped with a touchpad, joystick and a fully or partially touch screen display.

Referring to the second embodiment of the invention the above mentioned technical result is achieved as follows:

An electronic device, wherein a touchpad or a part (sector) of a touchpad or a joystick is made so as to move along the electronic device body.

The electronic device may be a mobile phone or a smartphone or a communicator or a multimedia device or a netbook or a notebook or a tablet computer or an electronic book or a digital camera or a camcorder or other electronic device equipped with a touchpad or other electronic device equipped with a joystick or other electronic device equipped with a touchpad and with a joystick or other electronic device equipped with a touchpad and a fully or partially touch screen display or other electronic device equipped with a joystick and a fully or partially touch screen display or other electronic device equipped with a touchpad, joystick and a fully or partially touch screen display.

Referring to the third embodiment of the invention the above mentioned technical result is achieved as follows:

An electronic device comprising a touchpad, wherein a touchpad or a part (sector) of a touchpad has a fully or partially convex shape.

The electronic device may be a mobile phone or a smartphone or a communicator or a multimedia device or a netbook or a notebook or a tablet computer or an electronic book or a digital camera or a camcorder or other electronic device equipped with a touchpad.

Referring to the fourth embodiment of the invention the above mentioned technical result is achieved as follows:

An electronic device comprising a touchpad and a joystick, wherein:

At least one touchpad or at least one part (sector) of a touchpad or at least one joystick or a part of it is arranged on the rear side of the electronic device body, or

A touchpad or a part (sector) of a touchpad is arranged at once on the lateral side and on the rear side of the electronic device body, herewith a touchpad itself has at least one bending, or

A touchpad or a part (sector) of a touchpad is arranged at once on the front side, lateral side and on the rear side of the electronic device body, or

A touchpad or a part (sector) of a touchpad or a joystick is arranged over the rear side of an electronic device fully or partially, herewith a touchpad or a part of a touchpad or a joystick is connected to the body of an electronic device.

A touchpad or a part (sector) of a touchpad may have a fully or partially convex shape.

A touchpad or a part (sector) of a touchpad or a joystick may be protected with a protective cover.

A touchpad or a part (sector) of a touchpad or a joystick and an electronic device may functionally interact with each other via a wired connection and/or via a radio communication.

The electronic device may be a multimedia device or another electronic device comprising a touchpad and a joystick.

Referring to the fifth embodiment of the invention the above mentioned technical result is achieved as follows:

An electronic device comprising a touchpad, a visual display and a joystick, wherein at least one touchpad or at least one part (sector) of a touchpad or at least one joystick or a part of it is arranged on the rear side of the electronic device body to function in said arrangement, herewith the user of the electronic device through manipulations with the touchpad or a part (sector) of the touchpad or with the joystick or a part of the joystick controls at least one virtual symbol displayed at least on one visual display arranged on the front side of the electronic device body, or

A touchpad or a part (sector) of a touchpad is arranged at once on the lateral side and on the rear side of the electronic device body, herewith a touchpad itself has at least one bending, or

A touchpad or a part (sector) of a touchpad is arranged at once on the front side, lateral side and on the rear side of the electronic device body, or

A touchpad or a part (sector) of a touchpad or a joystick is arranged over the rear side of an electronic device fully or partially, herewith a touchpad or a part of a touchpad or a joystick is connected to the body of an electronic device.

On a touchpad or a part (sector) of a touchpad may be created at least one sector through which at least one virtual symbol displayed at least on one visual display, arranged on the front side of the electronic device body, may be controlled.

A touchpad or a part (sector) of a touchpad may have fully or partially convex shape.

A touchpad or a part (sector) of a touchpad or a joystick may be protected with a protective cover.

A touchpad or a part (sector) of a touchpad or a joystick may replace the protective cover of a camera lens or the protective cover of a camcorder lens or it may be placed on the protective cover of a camera lens or on the protective cover of a camcorder lens.

A touchpad or a part (sector) of a touchpad or a joystick and an electronic device may functionally interact with each other via a wired connection and/or via a radio communication.

The surface area of a touchpad arranged on the rear side of the electronic device body may be equal or less than the surface area of a visual display arranged on the front side of the electronic device body.

To protect a touchpad or a part (sector) of a touchpad an additional visual display may be provided in the electronic device; herewith to access a touchpad mentioned additional visual display is moved aside.

A display of an electronic device may be completely or partially touch screen display.

The electronic device may represent a mobile phone or a smartphone or a communicator or a multimedia device or a netbook or a notebook or a tablet computer or an electronic book or a digital camera or a camcorder or another electronic device comprising a touchpad, a visual display and a joystick.

Referring to the sixth embodiment of the invention the above mentioned technical result is achieved as follows:

An electronic device comprising a visual display, wherein the visual display is arranged at least on three sides of the body of an electronic device, herewith the said visual display is a fully or partially touch screen display.

A visual display may be arranged on two opposite sides and at least on one lateral side of the electronic device body.

At least one virtual symbol, displayed on the said visual display, may be controlled through manipulations on the touch screen display part.

At least one controlled virtual symbol may be displayed on that part of the visual display, which is located on the opposite side (sides) of the electronic device relative to the side, where the manipulations are performed.

A part of a visual display arranged on the lateral side of an electronic device body may be fully or partially protected by a cover or covers.

A protective cover or a part of a protective cover may be transparent or semi-transparent.

A part of a visual display arranged on the lateral side of an electronic device body may have a lager thickness and/or may have on its surface convex shapes and/or may be made of harder materials.

The electronic device may be a mobile phone or a smartphone or a communicator or a multimedia device or a netbook or a notebook or a tablet computer or an electronic book or a digital camera or a camcorder or another electronic device comprising a fully or partially touch screen display.

### PREFERRED EMBODIMENT OF THE INVENTION

The method of arrangement of a touchpad, a joystick and a visual display in an electronic device described herein is feasible as can be realized due to application of prior art technical solutions and technologies.

The devices described herein in the second embodiment of the invention, in the third embodiment of the invention, in the fourth embodiment of the invention, in the fifth embodiment of the invention and in the sixth embodiment of the invention are feasible as can be realized due to application of prior art technical solutions and technologies.

### APPLICATIONS OF THE INVENTION

The method and devices for realization of the method may be applied to expand functional capabilities of electronic devices comprising a touchpad or to expand functional capabilities of electronic devices comprising a touchpad and a joystick, or to expand functional capabilities of electronic devices comprising a touchpad, a visual display and a joystick, or to expand functional capabilities of electronic devices comprising fully or partially touch screen display.

1. A method of arrangement of a touchpad, a joystick and a visual display in an electronic device, wherein:
a touchpad or a part (sector) of a touchpad or a joystick is arranged partially on the rear side of the electronic device body, or
a touchpad or a part (sector) of a touchpad is arranged at once on the lateral side and on the rear side of the electronic device body, herewith a touchpad itself has at least one bending, or
a touchpad or a part (sector) of a touchpad is arranged at once on the front side, lateral side and on the rear side of the electronic device body, or
a touchpad or a part (sector) of a touchpad or a joystick is arranged over the rear side of an electronic device fully or partially, herewith a touchpad or a part of a touchpad or a joystick is connected to the body of an electronic device, or
a fully or partially touch screen display is arranged at least on three sides of a body of an electronic device.

2. The method according to claim 1, wherein an electronic device is a mobile phone or a smartphone or a communicator or a multimedia device or a netbook or a notebook or a tablet computer or an electronic book or a digital camera or a camcorder or other electronic device equipped with a touchpad or other electronic device equipped with a joystick or other electronic device equipped with a touchpad and with a joystick or other electronic device equipped with a touchpad and a fully or partially touch screen display or other electronic device equipped with a joystick and a fully or partially touch screen display or other electronic device equipped with a touchpad, joystick and a fully or partially touch screen display.

3. An electronic device, wherein a touchpad or a part (sector) of a touchpad or a joystick is made so as to move along the electronic device body.

4. The electronic device according to claim 3, wherein the electronic device is a mobile phone or a smartphone or a communicator or a multimedia device or a netbook or a notebook or a tablet computer or an electronic book or a digital camera or a camcorder or other electronic device equipped with a touchpad or other electronic device equipped with a joystick or other electronic device equipped with a touchpad and with a joystick or other electronic device equipped with a touchpad and a fully or partially touch screen display or other electronic device equipped with a joystick and a fully or partially touch screen display or other electronic device equipped with a touchpad, joystick and a fully or partially touch screen display.

5. An electronic device comprising a touchpad, wherein a touchpad or a part (sector) of a touchpad has a fully or partially convex shape.

6. The electronic device according to claim 5, wherein the electronic device is a mobile phone or a smartphone or a communicator or a multimedia device or a netbook or a notebook or a tablet computer or an electronic book or a digital camera or a camcorder or other electronic device equipped with a touchpad.

7. An electronic device comprising a touchpad and a joystick, wherein:
at least one touchpad or a part (sector) of a touchpad or at least one joystick or a part of it is arranged on the rear side of the electronic device body, or
a touchpad or a part (sector) of a touchpad is arranged at once on the lateral side and on the rear side of the electronic device body, herewith a touchpad itself has at least one bending, or
a touchpad or a part (sector) of a touchpad is arranged at once on the front side, lateral side and on the rear side of the electronic device body, or
a touchpad or a part (sector) of a touchpad or a joystick is arranged over the rear side of an electronic device fully or partially, herewith a touchpad or
a part of a touchpad or a joystick is connected to the body of an electronic device.

8. The electronic device according to claim 7, wherein a touchpad or a part (sector) of a touchpad has a fully or partially convex shape.

9. The electronic device according to claim 7, wherein a touchpad or a part (sector) of a touchpad or a joystick is protected with a protective cover.

10. The electronic device according to claim 7, wherein a touchpad or apart (sector) of a touchpad or a joystick and an electronic device functionally interact with each other via a wired connection and/or via a radio communication.

11-21. (canceled)

22. An electronic device comprising a visual display, wherein the visual display is arranged at least on three sides of the body of an electronic device, herewith the said visual display is a fully or partially touch screen display.

23. The electronic device according to claim 22, wherein a visual display is arranged on two opposite sides and at least on one lateral side of the electronic device body.

24. The electronic device according to claim 22, wherein at least one virtual symbol, displayed on the said visual display, is controlled through manipulations on the touch screen display part.

25. The electronic device according to claim 24, wherein at least one controlled virtual symbol is displayed on that part of the visual display, which is located on the opposite side (sides) of the electronic device relative to the side, where the manipulations are performed.

26. The electronic device according to claim 23, wherein a part of a visual display arranged on the lateral side of an electronic device body is fully or partially protected by a cover or covers.

27. The electronic device according to claim 26, wherein a protective cover or a part of a protective cover is transparent or semi-transparent.

28. The electronic device according to claim 23, wherein a part of a visual display arranged on the lateral side of an electronic device body has a lager thickness and/or has on its surface convex shapes and/or is made of harder materials.

29. The electronic device according to claim 22, wherein the electronic device is a mobile phone or a smartphone or a communicator or a multimedia device or a netbook or a notebook or a tablet computer or an electronic book or a digital camera or a camcorder or another electronic device comprising a fully or partially touch screen display.

30. An electronic device comprising a touchpad, a visual display and a joystick, wherein:
at least one touchpad or at least one part (sector) of a touchpad or at least one joystick or a part of it is arranged on the rear side of the electronic device body to function in said arrangement, herewith the user of the electronic device through manipulations with the touchpad or a part (sector) of the touchpad or with the joystick or a part of the joystick controls at least one virtual symbol displayed at least on one visual display arranged on the front side of the electronic device body, or
a touchpad or a part (sector) of a touchpad is arranged at once on the lateral side and on the rear side of the electronic device body, herewith a touchpad itself has at least one bending, or
a touchpad or a part (sector) of a touchpad is arranged at once on the front side, lateral side and on the rear side of the electronic device body, or
a touchpad or a part (sector) of a touchpad or a joystick is arranged over the rear side of an electronic device fully or partially, herewith a touchpad or a part of a touchpad or a joystick is connected to the body of an electronic device.

31. The electronic device according to claim 30, wherein a touchpad or a part (sector) of a touchpad or a joystick is protected with a protective cover.

32. The electronic device according to claim 30, wherein a touchpad or a part (sector) of a touchpad or a joystick replaces the protective cover of a camera lens or the protective cover of a camcorder lens or it is placed on the protective cover of a camera lens or on the protective cover of a camcorder lens.

33. The electronic device according to claim 30, wherein a touchpad or a part (sector) of a touchpad or a joystick and an electronic device are functionally interact with each other via a wired connection and/or via a radio communication.

34. The electronic device according to claim 30, wherein the surface area of a touchpad arranged on the rear side of the electronic device body is equal or less than the surface area of a visual display arranged on the front side of the electronic device body.

35. The electronic device according to claim 30, wherein to protect a touchpad or a part (sector) of a touchpad an additional visual display is provided in the electronic device; herewith to access a touchpad mentioned additional visual display is moved aside.

36. The electronic device according to claim 30, wherein a display of an electronic device is a completely or partially touch screen display.

37. The electronic device according to claim 30, wherein an electronic device is a mobile phone or a smartphone or a communicator or a multimedia device or a netbook or a notebook or a tablet computer or an electronic book or a digital camera or a camcorder or another electronic device comprising a touchpad, a visual display and a joystick.
